(19) United States
(12) Patent Application Publication
(10) Pub. No.: US 2003/0053433 A1
(43) Pub. Date: Mar. 20, 2003

(54) System and method for communicating between an automobile computer and a remote computer via a short range, high bandwidth communication link

(76) Inventor: Anthony L. Chun, Los Altos, CA (US)

Correspondence Address: KENYON & KENYON, 333 W. San Carlos Street, Suite 600, San Jose, CA, 95110-2711, US

(21) Appl. No.: 09/957,089

(22) Filed: Sep. 19, 2001

(51) Int. Cl. H04Q 7/24

(52) U.S. Cl. 370/338; 370/389

(57) ABSTRACT

A system and method for communicating between a vehicle data unit, such as a car computer, and a remote data unit, such as a home personal computer, commercial server, or another vehicle data unit, via a short range, high bandwidth communication link, such as via a wireless local area network (WLAN).

### BACKGROUND INFORMATION

The present invention relates to data communication. More specifically, the present invention relates to a system for communicating between a vehicle data unit, such as an automobile computer, and a remote data unit, such as a home personal computer, commercial server, or a second vehicle data unit, via a short range, high bandwidth communication link, such as via a wireless local area network (WLAN).

In the art today, there exists different methods to communicate digital information between a mobile computer and a remote computer. For example, files can be downloaded to a car computer, such as a navigation system, via a compact disc (CD) in a CD player/CD-ROM to (read-only memory) drive located in the vehicle. The files may include maps, etc. to be used in conjunction with the computer's global positioning system for the navigational aid of the driver. Further, some stereo systems are capable of decompressing and playing MP3 (Moving Picture Experts Group Layer-3 Audio)-compressed music files. These stereos may access the MP3 files via a CD player/CD-ROM drive located in the vehicle. Uploading files by CD-ROM requires that the actual physical medium (the CD) be carried between the place of storage or creation to the vehicle. Further, the CD is susceptible to being misplaced or damaged, rendering the files irretrievable.

Also, information may be communicated between mobile computers via long distance wireless protocols such as Wireless Wide Area Network (WWAN). However, transmission under protocols such as these are very limiting in bandwidth. Transmission rates of WWAN are typically from 1 to 32 Kilobits per second (Kbps). When trying to transfer large amounts of data between a mobile computer (such as a car computer) and a remote computer under such a protocol, long delays may be experienced due to the limited bandwidth.

It is therefore desirable to have a system for communicating between a vehicle data unit and a remote data unit without the need for relocation of a physical medium, such as a CD, and without the bandwidth restraints of long distance wireless protocols, such as WWAN.

### BRIEF DESCRIPTION OF THE DRAWINGS

FIG. 1 describes the operation of a ‘home-to-car’ local area network over a wireless medium, such as Wireless Local Area Network (WLAN), under principles of the present invention.

FIG. 2 provides further illustration of the ‘home-to-car’ WLAN system under principles of the present invention.

FIG. 3 illustrates the operation of a ‘commercial server-to-car’ Wireless Local Area Network (WLAN) system under principles of the present invention.

### DETAILED DESCRIPTION

Currently, many computer users have a personal computer (PC) at home that may be used to store such items as music files, emails, audio books, agendas, digital video, maps and directions. Much of this data may be useful to the user while he/she is commuting in the car to or from work, etc. The difficulty is in transferring the data efficiently from the home PC to the car.

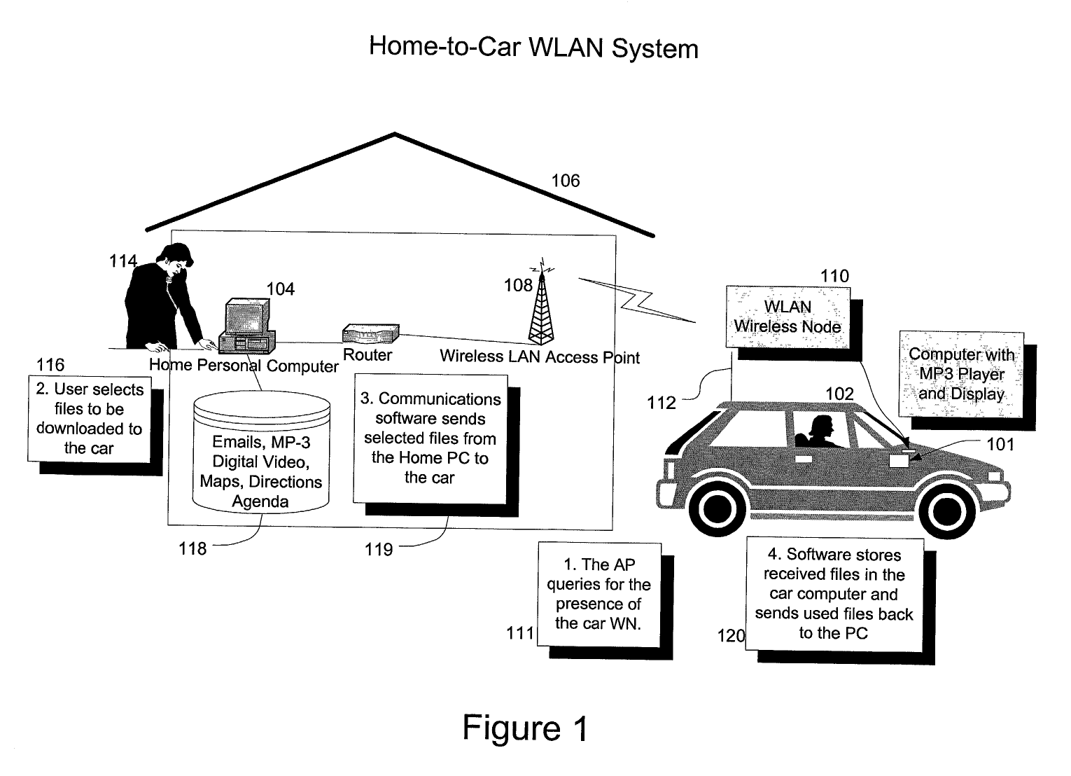

FIG. 1 describes the operation of a ‘home-to-car’ local area network over a wireless medium, such as Wireless Local Area Network (WLAN), under principles of the present invention. In one embodiment, an automobile 102 is equipped with a personal computer-like device 101, capable of storing and displaying such items as electronic maps, directions, traffic updates, agendas, email messages, newspaper articles, computer audio files (such as under the MP3 format) and digital video. In one embodiment, audio data can be played from the computer through the audio system. Further, in an embodiment, video may be displayed for the non-driving passengers. In an embodiment, the car computers will also be capable of browsing the Internet via a protocol such as Wireless Wide Area Network (WWAN).

In one embodiment, a WLAN access point (AP) 108 is installed in the garage or carport of a house. The AP 108 is analogous to a cellular base station and includes an antenna, RF transceiver, protocol software and data interfaces (none shown) that enable it to be connected via a wired or wireless connection to a network in the house that incorporates the user's home PC 104. In an embodiment, the WLAN can be based on an existing standard, such as Institute of Electrical & Electronics Engineers (IEEE) Standards 802.11 or 802.16 (IEEE, June 1997 and IEEE 802.16 Working Group, July 2001, respectively) or it could be based on a proprietary format. The WLAN is capable of transferring data at a high rate (54 Mbits per second) over a short distance (up to about 500 feet with building obstructions).

In one embodiment, a Wireless Node (WN) 110 is installed in the user's automobile 102. In an embodiment, the WN 110 is compatible with the wireless format used by the AP 108 and includes an antenna 112 (a separate antenna or perhaps integrated with the standard car radio antenna), radio transceiver, associated interfaces to the car computing device and the necessary physical and media access control software (not shown) to enable it to communicate with the AP 108.

In one embodiment, a computing device 101 exists in the user's automobile 102. In one embodiment, the computing device 101 may be similar to a Personal Digital Assistant (PDA) and may include a processor, memory, a user interface (such as a touchscreen) and an interface to the WN 110.

In an embodiment, software is installed on the home PC 104 and the car computer 101 for transferring files between the computers using the WLAN. In an embodiment, this software establishes a connection between the home PC 104 and the car computer 101 and transmits the data between them. In a possible embodiment, an encryption protocol could be included to provide privacy and security.

In an embodiment, the AP 108 continuously polls for the presence of a WN 110 by emitting queries 111. When the car is driven into the garage, the WN 110 in the car 102 to responds to a query with a valid response and a wireless connection is established between the car WN 110 and the AP 108.

With one embodiment of the invention, before driving to work, a user 114 selects files on his/her personal computer 104 that he/she would like to use that day 116. This might include music (in MP3 format, for example), maps, directions, agendas, movie times, restaurant reviews, emails (that could be read to the driver in the car via, for example, a text-to-speech synthesizer), audio books, foreign language lessons, digital video (to be viewed, for example, on a personal video screen by the non-driving passengers), etc. 118. In an embodiment, on the PC screen, the user may “drag” these files into a folder for transfer to the car computer 101. The transfer of the files via WLAN then proceeds automatically in an embodiment of the invention 119. In an embodiment, the protocol includes methods to verify the integrity of the received data. In one embodiment, as part of the process, previously used files in the car computer 101 may be sent back 120 from the car 102 to the home computer 104 via the WLAN to be archived, freeing up storage space in the car computer 101.

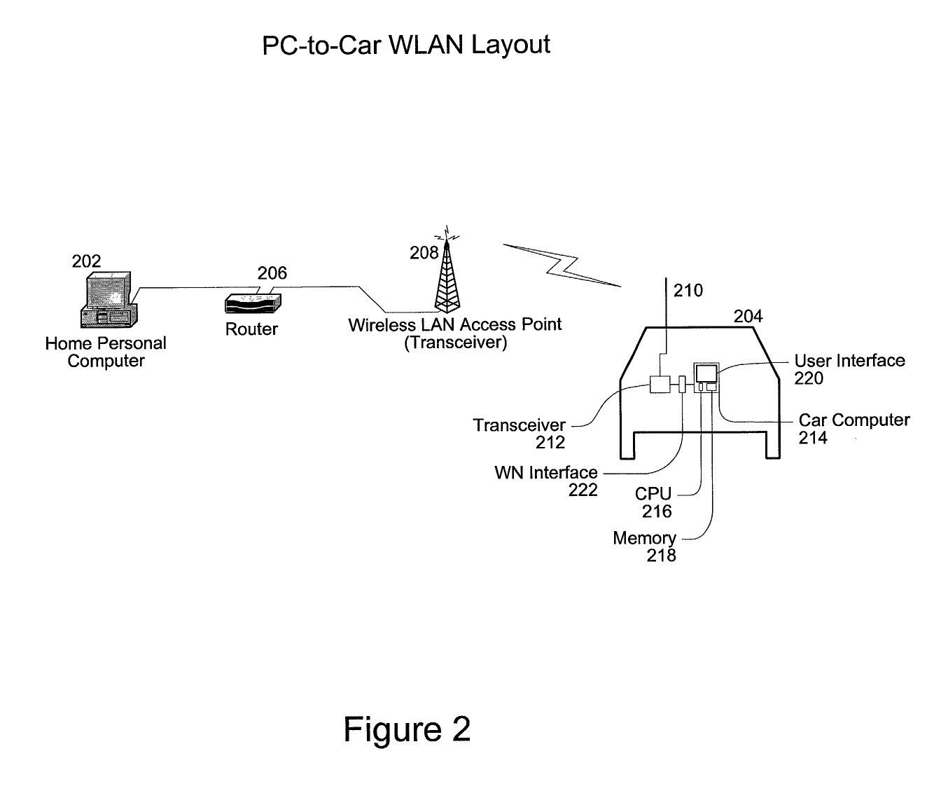

FIG. 2 provides further illustration of the ‘home-to-car’ WLAN system under principles of the present invention. As stated above, in one embodiment, files such as maps, emails, agendas, etc. can be downloaded from a home computer 202 to a user's vehicle 204 via a WLAN communication link. Scheduled through the network's router 206, in one embodiment, files are forwarded to the WLAN AP 208 to be transmitted to the vehicle 204. In an embodiment, the signal is received by the vehicle's antenna 210 (a separate antenna or the standard car radio antenna) with the radio transceiver 212. As stated, in one embodiment, the car computer 214 may be similar to a PDA and may include a central processing unit (CPU) 216, memory 218, a user interface (such as a touchscreen) 220 and an interface to the WN 222.

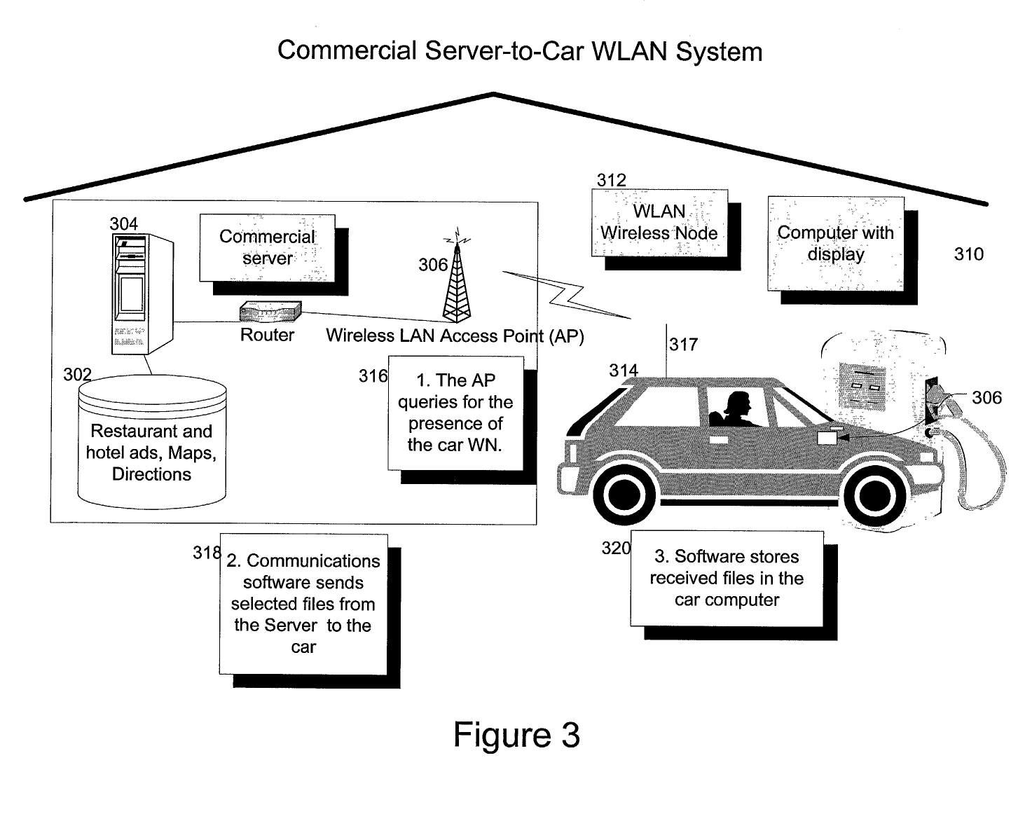

FIG. 3 illustrates the operation of a ‘commercial server-to-car’ Wireless Local Area Network (WLAN) system under principles of the present invention. In one embodiment, the wireless communications system is utilized for transmitting consumer information such as digital music, video, maps, directions, traffic updates, movie times, restaurant and hotel ads and reviews 302 from a commercial server computer 304 to the car computer 306. In an embodiment, potential locations for this commercial server 304 include: a) Gas stations—data transferred while the car is being filled up (e.g. electronic payment, records keeping, etc.); b) Tollbooths at bridges or parkways—data transferred while the toll is being paid (e.g. electronic toll payment, records keeping, town maps and attractions etc.); c) Ferries—data transferred while cars are parked in the ferry; d) Parking garages—data transferred while the driver enters or leaves the garage; and e) Car rental agencies—car rental agency could have a server and WLAN in its parking garage that would enable it to send data to the car computer before the driver picks up the car.

In one embodiment, a WLAN access point (AP) 308 exists at the gas station 310, tollbooth or at the entrance to the parking or rental garage. The AP 306 is analogous to a cellular basestation and includes an antenna, RF transceiver, protocol software and data interfaces (not shown) that enable it to be connected to a server 304 that stores data for the drivers. As stated, in an embodiment, a Wireless Node (WN) 312 exists in the user's automobile 314. In an embodiment, the WN 312 is compatible with the wireless format used by the AP 306 and includes an antenna 317 (separate or integrated), radio transceiver, associated interfaces (not shown) to the car computing device 308 and the necessary physical and media access control software (not shown) to enable it to communicate with the AP 306. In an embodiment, the AP 306 continuously polls for the presence of a WN 312 by emitting queries 316. When the car 314 is driven into the gas station 310 or stops at the tollbooth or parking garage, the WN 312 in the car 314 responds to a query with a valid response and a wireless connection is established between the car WN 312 and the AP 306. In an embodiment, after the connection is established and while the user is fueling or paying the toll or garage fee, maps, directions, movie times, restaurant reviews and ads are transmitted 318 to the car computer 308 (where they are stored 320) from the server 304 via the WLAN.

This invention may be particular useful to visitors of a city who are looking for services such as restaurants and/or hotels or who require directions. It is foreseen that revenue may be generated from ads sold to the local services. Further, as stated, using a WLAN instead of a WWAN is advantageous because higher data rates can be attained over the short distances. This is important when the data files are large, such as for music or video.

Although several embodiments are specifically illustrated and described herein, it will be appreciated that modifications and variations of the present invention are covered by the above teachings and within the purview of the appended claims without departing from the spirit and intended scope of the invention.

1. A system to communicate, the system comprising:
a first data unit of a first vehicle; and
a second data unit; wherein
said first data unit is capable of communicating with said second data unit via a communication link; and
said communication link includes a local area network.

2. The system of claim 1, wherein the communication link is via wireless transmission.

3. The system of claim 2, wherein the wireless transmission utilizes a wireless local area network (WLAN) protocol.

4. The system of claim 1, wherein the communication link is a wired connection.

5. The system of claim 4, wherein the wired connection utilizes a local area network (LAN) protocol.

6. The system of claim 3, wherein the first data unit is a vehicle stereo system.

7. The system of claim 3, wherein the first data unit is a first computer.

8. The system of claim 7, wherein the first computer is a vehicle computer.

9. The system of claim 3, wherein the second data unit is a personal data assistant (PDA).

10. The system of claim 3, wherein the second data unit is of a second vehicle.

11. The system of claim 3, wherein the second data unit is a second computer.

12. The system of claim 11, wherein the second computer is a personal computer.

13. The system of claim 3, wherein the second data unit is a commercial data unit.

14. The system of claim 13, wherein the commercial data unit is a toll booth computer system.

15. The system of claim 13, wherein the commercial data unit is a gasoline filling station computer system.

16. A method to communicate, the method comprising:
communicating by a first data unit of a first vehicle with a second data unit via a communication link; and
utilizing for said communication link a local area network.

17. The method of claim 16, wherein the communication link is via wireless transmission.

18. The method of claim 17, wherein the wireless transmission utilizes a wireless local area network (WLAN) protocol.

19. The method of claim 16, wherein the communication link is a wired connection.

20. The method of claim 19, wherein the wired connection utilizes a local area network (LAN) protocol.

21. The method of claim 18, wherein the first data unit is a vehicle stereo system.

22. The method of claim 18, wherein the first data unit is a first computer.

23. The method of claim 22, wherein the first computer is a vehicle computer.

24. The method of claim 18, wherein the second data unit is a personal data assistant (PDA).

25. The method of claim 18, wherein the second data unit is of a second vehicle.

26. The method of claim 18, wherein the second data unit is a second computer.

27. The method of claim 26, wherein the second computer is a personal computer.

28. The method of claim 18, wherein the second data unit is a commercial computer server.

29. A set of instructions residing in a storage medium, said set of instructions capable of being executed by a processor to communicate comprising:
communicating by a first data unit of a first vehicle with a second data unit via a communication link; and
utilizing for said communication link a local area network.

30. The method of claim 17, wherein the communication link utilizes a wireless local area network (WLAN) protocol.
